(19) United States
(12) Patent Application Publication
(10) Pub. No.: US 2007/0162335 A1
(43) Pub. Date: Jul. 12, 2007

(54) Advertiser Sponsored Media Download and Distribution Using Real-Time Ad and Media Matching and Concatenation

(76) Inventor: Gary C. Mekikian, La Canada, CA (US)

Correspondence Address: WILSON SONSINI GOODRICH & ROSATI, 650 PAGE MILL ROAD, PALO ALTO, CA, 94304-1050, US

(21) Appl. No.: 11/531,229

(22) Filed: Sep. 12, 2006

Related U.S. Application Data
(60) Provisional application No. 60/757,613, filed on Jan. 11, 2006.
(60) Provisional application No. 60/744,515, filed on Apr. 10, 2006.

(51) Int. Cl. G07G 1/14

(52) U.S. Cl. 705/14

(57) ABSTRACT

Methods and systems for distributing content. A method may include requesting, through a computer network, a download of particular content; receiving the particular content, wherein the particular content is combined with an advertisement; storing the particular content and the advertisement in a user's content play device; receiving a user request to play the particular content on the user's content play device; determining whether the advertisement has expired; if it is not determined that the advertisement has expired, in response to user request to play the particular content, playing the particular content on the content play device and the advertisement; and if it is determined that the advertisement has expired, in response to user request to play the particular content, playing the particular content on the content play device without playing the advertisement. Other approaches are possible in accordance with various embodiments.

This application claims the benefit of U.S. Provisional Application Nos. 60/757,613 filed Jan. 11, 2006, and 60/744,515, filed Apr. 10, 2006, each of which is incorporated herein by reference in its entirety.

### BACKGROUND OF THE INVENTION

A problem in the music download industry is that the cost and difficulty of downloading from legal sites are driving consumers to illegal music download sites. Advances in Internet, computer hardware, and software technologies have made it easier for users to find and illegally download copyrighted digital materials.

Some existing business methods include legal music download services that charge a fee per download or a subscription free, legal media streaming services that charge a subscription fee to stream selected media to users' computers, sites that broadcast free media over the Internet sponsored by advertisers, and illegal download sites.

The words “media” and “download” are used throughout the document to refer to any digitized content that can be stored in computers, and transmitted over the Internet. This includes digitized music, movies, music and other types of videos, e-books, audio books, e-magazines, and any other digital content that is copyrighted or not.

Today's consumers, armed with broadband Internet access, have a need to download and carry their media with them on portable devices, such as Apple's ipod and other mp3 file players.

### INCORPORATION BY REFERENCE

All publications and patent applications mentioned in this specification are herein incorporated by reference to the same extent as if each individual publication or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

These and other features and advantages of the present invention will become more apparent to those skilled in the art from the following detailed description in conjunction with the appended drawings in which:

The exemplary embodiments of the present invention will be described in connection with the appended drawing figures in which like numerals denote like elements.

FIG. 1 is a block diagram illustrating the overall business method system, according to an embodiment of the invention.

FIG. 1B is a block diagram showing an example of how an embodiment works at a high level, according to an embodiment of the invention.

FIG. 1C is a block diagram depicting an overall advertisement and media processing system, according to an embodiment of the invention.

FIG. 1.1 is a flow diagram showing the copyright holder registration process, according to an embodiment of the invention.

FIG. 1.2 is a flow diagram illustrating the media posting and sponsor selection process, according to an embodiment of the invention.

FIG. 1.4 is a flow diagram showing the advertiser registration process, according to an embodiment of the invention.

FIG. 1.5 is a flow diagram showing the steps involved in the sponsor selection bidding process, according to an embodiment of the invention.

FIG. 1.5.5 is a flow diagram depicting a process to post advertisements and establish an advertising campaign, according to an embodiment of the invention.

FIG. 2 is a block diagram showing the overview of member and media processing, according to an embodiment of the invention.

FIG. 2.1 is a flow diagram depicting the member registration process, according to an embodiment of the invention.

FIG. 2.2 is a flow diagram illustrating the member media request and download process, according to an embodiment of the invention.

FIG. 2.2.6 is a flow diagram showing a process to select and stitch advertisements to media, according to an embodiment of the invention.

FIG. 2.3 is a flow diagram illustrating the media version monitoring and replacement process, according to an embodiment of the invention.

FIG. 3.1 is a block diagram illustrating a system, which may download various media content and advertisements, according to an embodiment of the invention.

FIG. 3.2 is a block diagram showing the architecture of a web server system, according to an embodiment of the invention.

FIG. 3.3 is a block diagram showing the steps that take place within a web server when a user requests digital content, according to an embodiment of the invention.

FIG. 3.4 is a flow diagram showing the steps that take place within a web server when a user requests digital content, according to an embodiment of the invention.

FIG. 3.5 is a block diagram illustrating how DRM encodes the file to be delivered to the user, according to an embodiment of the invention.

FIG. 3.6 is a block diagram illustrating how DRM encodes and decodes the packaged files, according to an embodiment of the invention.

FIG. 3.7 is a block diagram showing the architecture of the content play device, according to an embodiment of the invention.

FIG. 3.8 is a flow diagram depicting what happens on the client side during profile-driven advertising, according to an embodiment of the invention.

FIG. 3.9 is a flow diagram depicting what happens on the client side during event-driven advertising, according to an embodiment of the invention.

### DETAILED DESCRIPTION

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

An embodiment of the invention uses the Internet and other hardware, software, and networking technologies to offer advertiser sponsored legal download of music, movies, audio books, e-books, and other digital copyrighted and un-copyrighted media.

An embodiment of the invention is directed to a method of allowing sponsored user download of digital content from a web server. Copyright holders, such as media companies post digitized content to a web site and indicate a minimum price that must be paid per download. Sponsors, including advertisers or various organizations, post advertisements in various formats, and bid to sponsor a download, or agree to sponsor downloads based on pre-arranged advertising fees they agree to pay. Sponsors may choose to sponsor downloads for particular users, songs, artists, or events. Sponsors may also specify advertisement preferences, such as where in the content the advertisement will play and what causes it to expire.

Users may register as members of the web site and request to download sponsored digital content free of charge. When they register, users fill out a user profile. After users make a request for content, an algorithm finds and appends one or more advertisements depending on the sponsor preferences and bids. Users receive a packaged file containing the requested digital content and possibly containing advertisements, which may expire after a set period or event. When the transaction is completed, sponsors get to deliver advertisements to a target audience and pay a fee for advertising, part of which goes to compensate the copyright holders. Users initially own downloaded files that contain advertising until the advertisements expire, and then have only the requested digital content free of charge.

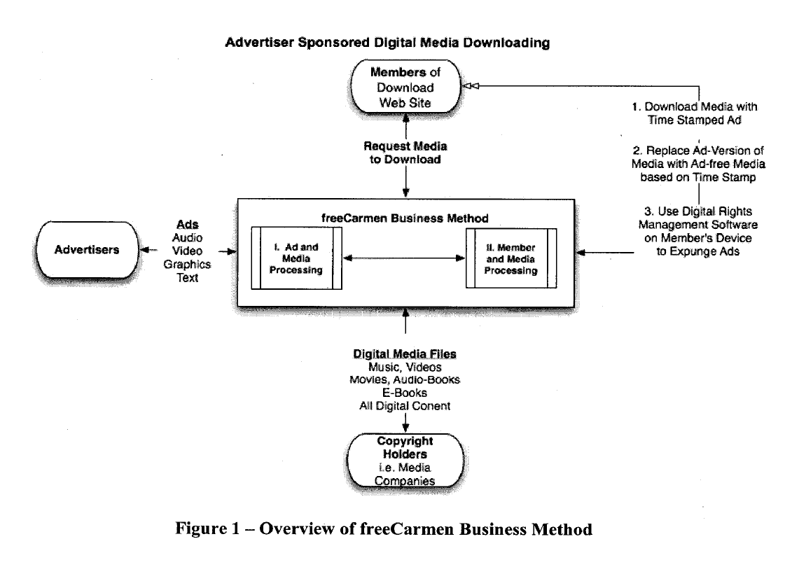

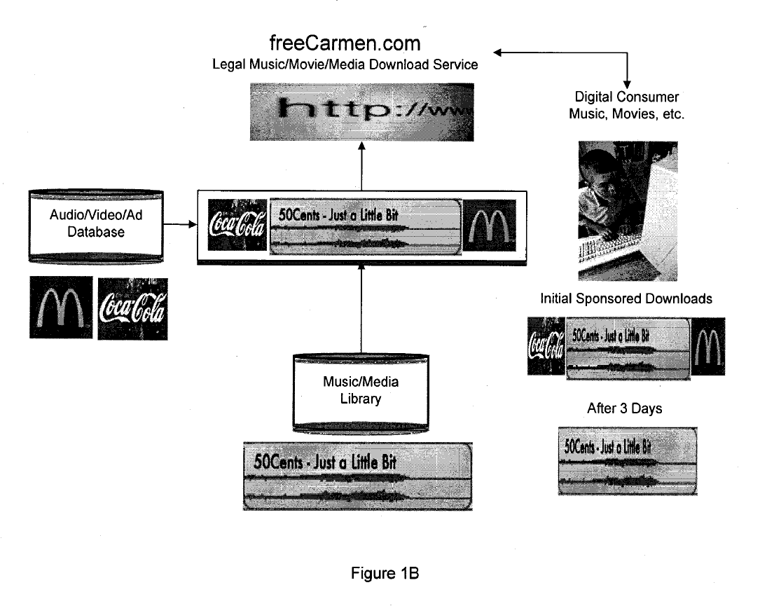

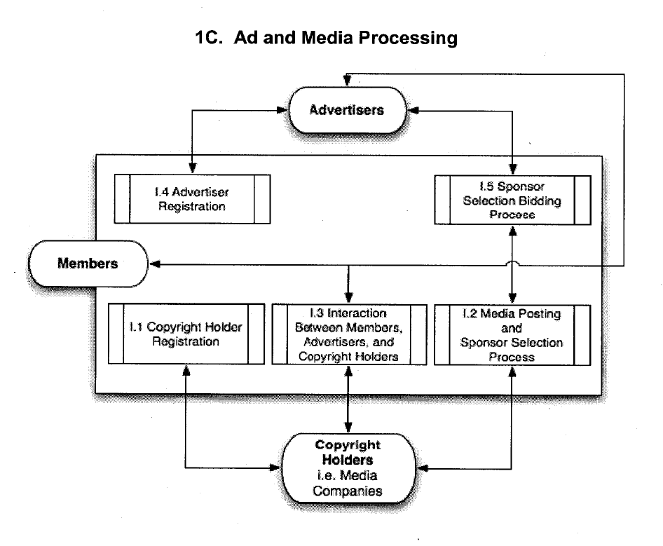

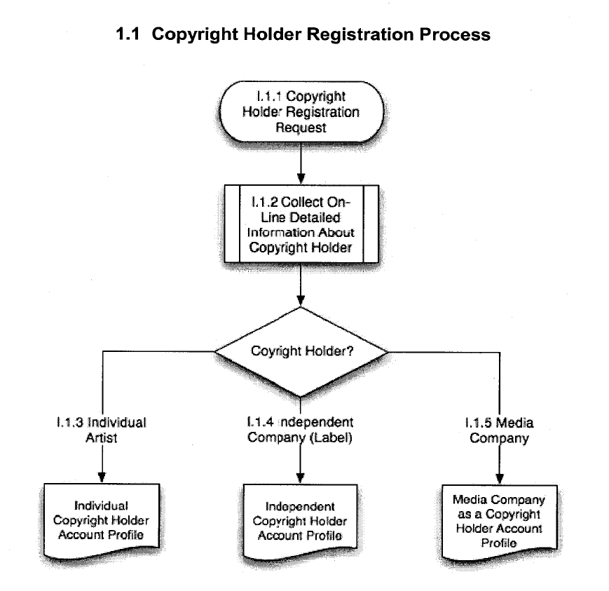

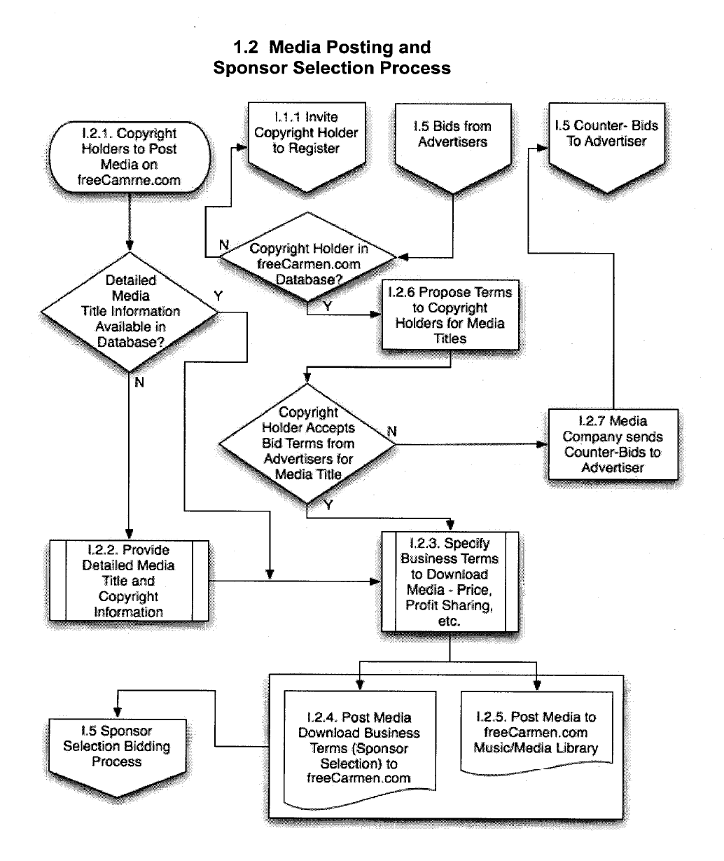

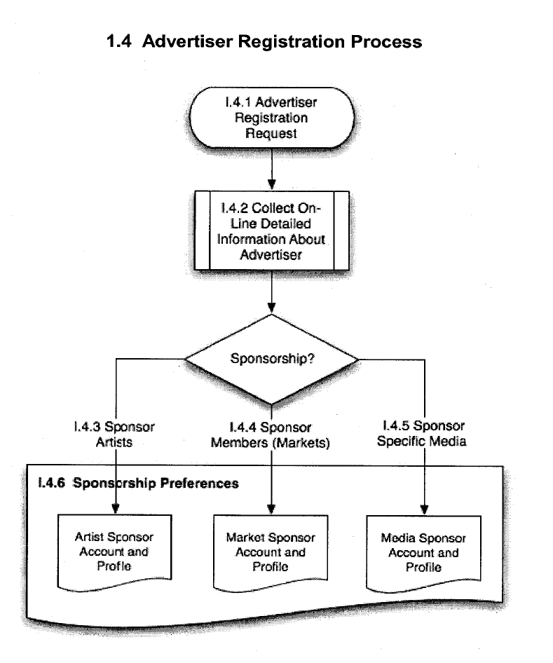

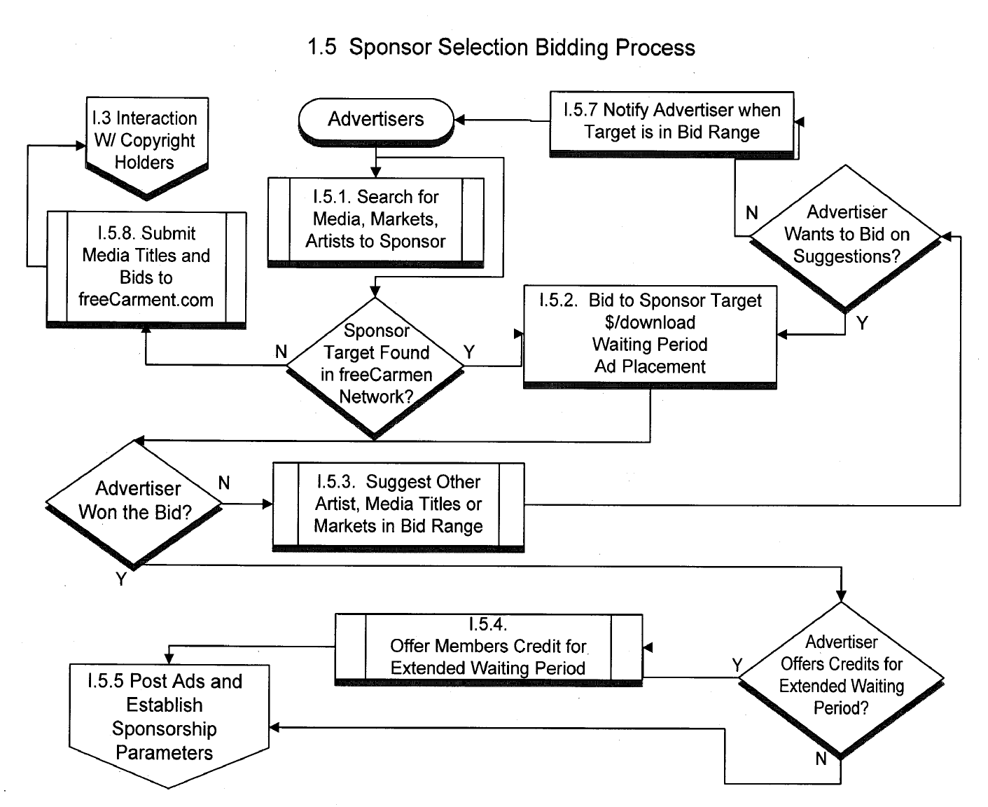

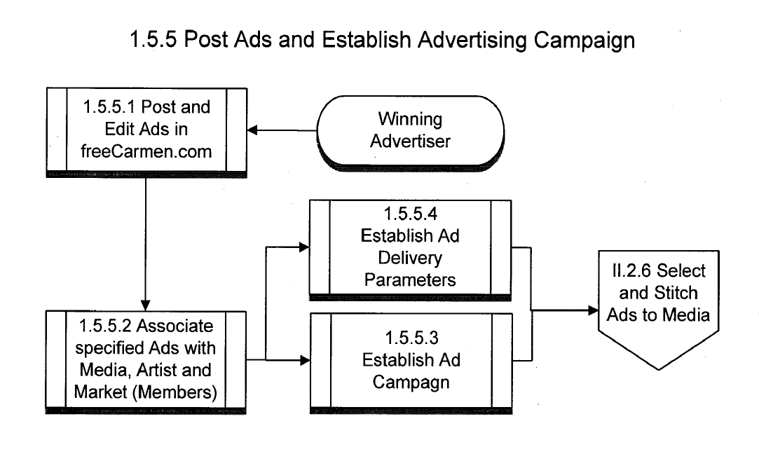

FIG. 1 depicts a block diagram illustrating the overall business method system, according to an embodiment of the invention. As the diagram shows, copyright holders, such as media companies, post digitized copyrighted (or otherwise) materials to the system web site. As they post the files, they also indicate a minimum price that copyright holders must be paid for each download.

Sponsors, which include but are not limited to advertisers, government organizations, and non-government organizations, post advertisements in audio, video, graphics, and text formats. They also indicate how much they are willing to pay to sponsor a media file download, to have their advertisements included in the media files that are delivered to consumers. Note that certain types of sponsors, such as charities, governments and non-government organizations, may choose to simply sponsor downloads for certain types of members, without asking to deliver any advertisements. For example, a charity that supports inner-city youth may sponsor free downloads for members who are verified as inner city youth. Likewise, a church may sponsor free downloads for its members, or any audience they choose to identify as their target audience.

To be able to download sponsored media, digital consumers become members of the system's web site. After becoming members, they can request to download sponsored files free of charge. If files requested by members are sponsored, they will download the sponsored version of the desired files, which may contain advertisements. The files containing advertisements are time-stamped by the system, which allows the system web site or a special software called digital rights management software residing on the member's device, to automatically expunge the advertisements from the downloaded files after a waiting period specified by the advertiser. When the transaction is completed, the sponsor (advertiser) gets to deliver advertisements to his target audience (members) and pays a fee for advertising. A portion of the fees paid by the sponsor is used to compensate the copyright holder for the downloaded files. The members initially own downloaded files that contain advertising, and after a certain period of time, when the advertising is expunged, they own an ad-free version of the file free of charge.

Alternatively or concurrently, the sponsor may chose to simply play its advertising in the member's Internet browser, while the member is downloading the sponsored media file. Since most media files are multiple megabytes in size, and it could take anywhere from 5 seconds to minutes to download the file, sponsors can chose to deliver their advertising during this period.

An embodiment includes two major processes. The first is advertisement and media processing, which includes all the major functions involved in posting media and advertising. Furthermore, it describes a bidding engine, which determines the economics of delivering advertisements with media, and links them for download upon member request.

The second process is member and media processing, which registers members as authorized users of the system, allows the members to request media downloads, packages requested media with appropriate advertisements, and downloads the digital packages to a member's devices.

FIG. 1B is a block diagram showing an example of how an embodiment works at a high level, according to an embodiment of the invention. One embodiment of the present invention allows the system to interact with the member to deliver content to the member.

In this example, a member of the system requests a song by 50 Cent (the artist). The system identifies two advertisers who would like to sponsor the download by having their audio advertisements delivered to the member along with the song. The system then stitches an advertisement by McDonalds to the beginning of the song, and another by Coca-Cola to the end of the song, thus creating the ad-version of the song in mp3 format. The member initially gets a legal download of the ad-version of the song with a time-stamp. Subsequently, the system monitors the time-stamp of this download, and after 3 days (could be longer or shorter), it replaces the ad-version of the song with a free, legal, ad-free version of the song. The following sections provide detailed description of the system's processes and sub-processes.

FIG. 1C is a block diagram depicting an overall advertisement and media processing system, according to an embodiment of the invention. The copyright holders and advertisers post content and advertisements.

FIG. 1.1 is a flow diagram showing the copyright holder registration process, according to an embodiment of the invention. In order to post content, a copyright holder registers with the system. This process allows copyright holders of all types of digital media, including music, movies, videos, e-nooks, audio-books, magazines, lectures, seminars, etc., to register with the system website as a provider of digital media available for sponsored download or outright sale. Sponsored download means allowing members of the site to download copyrighted materials which include advertisements by advertisers, or sponsors who pay fees that cover the price asked by copyright holders.

Copyright holders can visit the system web site and request to register as a provider of digital media for sponsored downloads. Copyright holders provide detailed information about the entity or entities that own copyrighted materials. This information includes name, address, contact information, and types of media the entity would like to make available for sponsored downloads. Copyright holders also agree (electronically) to the terms and conditions of making their media available for sponsored downloads.

Copyright holders identify themselves as individual artists, independent media companies or major media companies. Complete profile information is then provided based on the type of registration requested. Upon the conclusion of this process, copyright holders are provided with user names and passwords that allow them to access the system web site.

FIG. 1.2 is a flow diagram illustrating the media posting and sponsor selection process, according to an embodiment of the invention. After copyright holders are registered, they may upload content and sponsors are selected. Registered copyright holders post media to the system web site to make them available for sponsored downloading. First, copyright holders are invited by advertisers and/or members to post their media on the system web site. Copyright holders can also post their media without being prompted. If the system media database does not already contain detailed information, it is provided in this step. Information collected in this step includes the title of media (including version), author or artist, type of media (i.e. movie, music, etc.), digital format of media (i.e. mp3 or acc, mpeg, pdf, etc.), and size of media (in kilobytes or megabytes).

The copyright holder can specify the business terms for sponsored downloading by genre, artist/author, media title, or other criteria. The business terms include the minimum price the copyright holder must receive to allow for sponsored downloading of a media title, the share of profits copyright holder can specify, and any restrictions the copyright holder may place on the usage and further distribution of media.

After specifying media titles and associated business terms, a copyright holder may post the business terms on the system database.

In a separate step, copyright holders upload digitized versions (in formats specified in 1.2.2) of their media to the system database. Advertisers use this information provided in step 1.2.4 to bid on sponsoring media. Members search and download from the music/media library where copyright holders post their media in step 1.2.5.

In some instances, members may request a specific media title that a copyright holder has not posted in the system database. In this case, using the bidding process described in 1.5 below, an advertiser can submit a bid for the media title. If the system does not have information about the copyright holder of the media title in question, an invitation will be sent to the copyright holders to register with the system web site and post the media title in question (step 1.1.1).

If a copyright holder is registered, but the media title it owns is not posted, the system web site allows the advertiser to propose a business term to the copyright holder to induce it to post the media title in question. The copyright holder can agree to the terms, and carry on to steps 1.2.3 and beyond, or in step 1.2.7, send a counter-bid to the advertiser. This process can repeat until an agreement is reached.

Members, copyright holders, and advertisers interact with each other to facilitate processes. They interact when copyright holders ask advertisers to sponsor their media for sponsored downloading. Also, copyright holders perform market research for the media by gauging interest from members for sponsored downloads, and advertisers, for sponsoring at different price points. Members ask copyright holders to post desired media titles for sponsored downloading. Advertisers propose sponsorship for media title, artists, authors, or combination thereof to copyright holders. Members rate advertiser advertisements, allowing advertisers to fine-tune their advertisements for effectiveness and value to members. Furthermore, members rate media, allowing advertisers to select targets for sponsorship (media, artists, authors, etc.).

FIG. 1.4 is a flow diagram showing the advertiser registration process, according to an embodiment of the invention. This process allows advertisers to register at the system web site as sponsors for media downloads. Advertisers provide detailed information about the entities they represent, including advertiser entity and contact information, advertiser target audience demographics, and advertiser target audience profiles which are used to match advertisers with the system's members based on the profile of members, their media consuming patterns, and other activities that signify preferences.

In steps 1.4.3-1.4.5, advertisers specify their sponsorship preferences. They can choose to sponsor specific artists and authors, specific markets based on member profiles, and/or specific media titles. In step 1.4.6, advertisers create accounts and record their preferences for sponsorship. At the conclusion of the 1.4 process, advertisers are given user names and passwords that allow them to access the system web site and all of its capabilities as they apply to advertisers.

FIG. 1.5 is a flow diagram showing the steps involved in the sponsor selection bidding process, according to an embodiment of the invention. Once they are registered, sponsors may bid to sponsor requests to download content. This process defines how advertisers post advertisements in the system's advertisement database, bid to sponsor media, and upon winning the bid, specify advertisements that are to be delivered with the media. Furthermore, advertisers establish advertisement delivery parameters that direct the specifics of advertisement placement, consumption by members, and ultimate deletion of the advertisements from sponsored media.

Registered advertisers may use the system web site's search capabilities to search for targets to bid on as sponsors. Advertisers can search based on several criteria. One such criteria is the media title. Sponsoring a media title means that every time a member requests to download a media title, the advertiser that is identified as the sponsor of this media title, has the right to have its advertisements stitched to the media title in question, and the package delivered to the member. For example, a registered advertiser can search for the song “Silent Night” by the artist, Bing Crosby. When the media title is found in the system's network (database or other members in P2P mode), the advertiser can choose to sponsor this title (through a bidding process). Once its sponsorship is established, every time a member attempts to download this title, the system will attach the sponsor's advertisements to the media and deliver the package to the member.

Advertisers may also search by artist or author. Advertisers can choose to sponsor all the works of an artist or an author, or a category of their works as defined by genre, dates of release, version, format, or other criteria. In this case, any media title by the artist or the author in a given category is associated with the sponsor of that category.

Advertisers may target specific markets. Advertisers can also choose to sponsor downloads by certain members, or category of members based on their profiles and on-line usage and activity patterns. For example, advertisers can search the system's member database for all members who are in the 13-18 year age group, who have Chinese heritage, and are female. Sponsoring this market means that any member of this group who downloads sponsored media will also receive advertisements by the advertiser who chose to choose to sponsor this group of members as a target audience or market.

If the system's music/media database does not contain the desired media titles or artists/authors, advertisers can submit requests to the system, through the interaction process defined in 1.3, to invite the copyright holders to post the media titles and the works of the artists/authors in question (through step 1.5.8), to the system web site for sponsored downloading.

Advertisers bid to sponsor their desired targets as defined in 1.5.1 above. The bidding process is facilitated by the functions of the system web site, that allow for on-line viewing of minimum bids, existing bids by other advertisers, and the amounts and conditions that must be bid to win the rights to sponsor the target in question.

Advertisers submit certain information during the bidding process. Such information includes fees (in dollars and other currencies). Fees are how much an advertiser is willing to pay to sponsor each download of a media title.

Advertisers also submit information about the waiting period (condition). This is a time period that a member who downloaded the ad-version of media must wait, before the ad-version is replaced by the ad-free version of the media. For example, an advertiser can specify that a member must consume the ad-version of the media for 5 days, before an ad-free version of the media is made available to the member.

Advertisers also specify advertisement placement (condition). This is a physical location in the media into which the sponsor wants to insert its ads. For example, the advertiser can choose to have a 5 second audio advertisement placed at the beginning of a song (in mp3 format), thus making sure that the consumer listens to its advertisement every time before the song starts playing. Advertisements can have various placement alternatives depending on the media type.

There are several placement alternatives according to different embodiments of the present invention. For mp3 music an advertiser may choose to place audio advertisements in the beginning and end of the song. For mpeg movies, TV shows, and other videos an advertiser may place video advertisements in the beginning, end, and anywhere in-between. For audio books advertisers may place audio advertisements in the beginning, end, and anywhere in-between. For e-books an advertiser may place text/graphics advertisements in the beginning, end, and anywhere in-between.

The bidding process may produce more than one winner per target based on the placement preference of the advertisers. For example, one advertiser may win the bid to place its advertisements in the beginning of Bing Crosby's “Silent Night, and a second advertiser may win the bid to place its advertisements at the end. For digital television shows, a dozen advertisers may win sponsorship positions in different placement locations of the show.

The bidding process ends in the selection of advertisers as sponsors for targets. The criteria used to establish the winning advertisers can be modified based on the minimum fee requirements imposed by the copyright holders, and the system's profit objectives.

If an advertiser wins the bid for the target in question, the advertiser can then choose to offer download credits to members who download the sponsored media. For example, the winning bid may subject the members who download Bing Crosby's “Silent Night” to a waiting period of 3 days before the ad-version of the song is replaced with the ad-free version. Every time a member attempts to download the song, the advertiser can offer waiting period credits, such as 10 cents for every additional day the member chooses to keep the ad-version of the song, beyond the initial 3 days. If the member chooses to accept the waiting period credit, the member's account will be credited by 10 cents for every additional day. The member can then choose to spend her accumulated credits to download another song that does not have sponsors, and could not, otherwise, be downloaded for free, in a sponsored mode.

FIG. 1.5.5 is a flow diagram depicting a process to post advertisements and establish an advertising campaign, according to an embodiment of the invention. Sponsors may choose to post advertisements and create an advertising campaign. This process allows advertisers to post advertisements to the system's advertisement database, associate the advertisements with sponsored media (that they won through the bidding process), establish the advertisement delivery parameters, and define a campaign.

During the first step, advertisers upload advertisements of their choice produced in digital formats that are appropriate for concatenation to media, and subsequent delivery. These advertisements are posted to a database, and associated with the advertisers' account, such that they can have easy access to the advertisements for selection and stitching as described in step 1.2.6 below.

In a subsequent step, advertisers associate posted advertisements with targets that they won for sponsorship through the bidding process. These associations are not permanent. Rather, they are active only during a period of time where the advertiser is still the winning bidder for the target in question. If another advertiser wins the right to sponsor the target, the system breaks the association, and allows the new winner to associate its own advertisements with the targets.

In a following step, the advertiser establishes the campaign parameters for advertising. The parameters include the maximum number of advertisement deliveries per period, per target (minute, hour, day, week, month, etc.). and the budget per period.

When the maximum number of advertisement deliveries is achieved for the target, the advertiser can either increase the number, or release the sponsored target to other advertisers with lower bids. For example, let's say that an advertiser chooses to sponsor up to 10,000 downloads of Bing Crosby's “Silent Night” per day, as the winning sponsor for this song. When 10,000 advertisements are delivered in a day, the song is released to the next highest bidder to download during that day. The following day, “Silent Night” will reverse back to that advertiser until its advertisement delivery quota for the following day is reached.

The budget per period can be established in terms of maximum expenditure delivering advertisements per day, or week, or any other time period. When the specified budget is exhausted during a period, the advertiser can either increase the budget, or release the sponsored targets to other advertisers with lower bids during that period.

In another step, advertisers establish the parameters that dictate the delivery of the advertisements, including where the advertisements are placed in the media, the time period that a member who downloaded the ad-version of media must wait, before the ad-version is replaced by the ad-free version of the media, and credits a member can earn by agreeing to a longer waiting period.

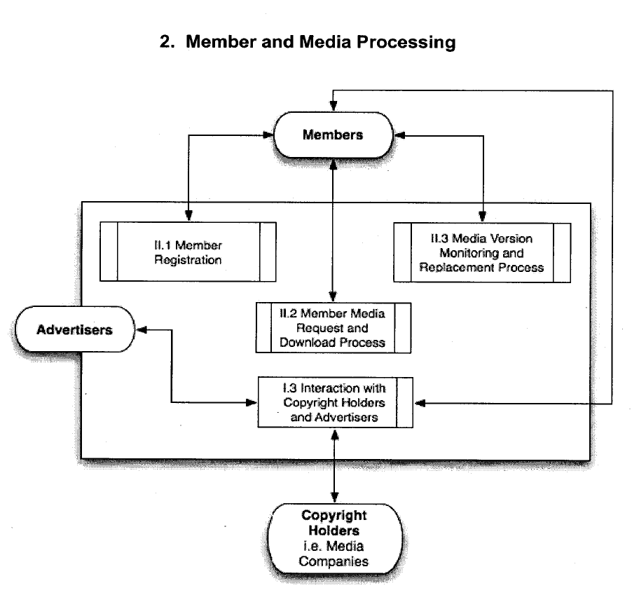

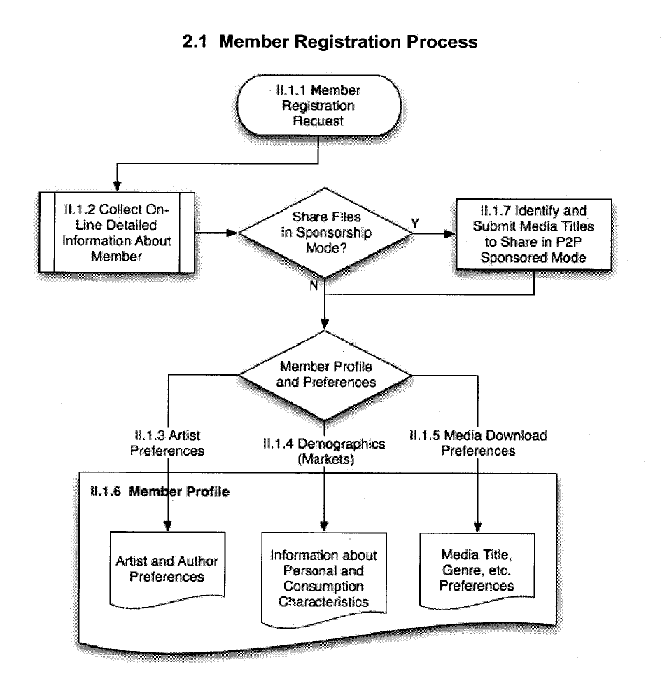

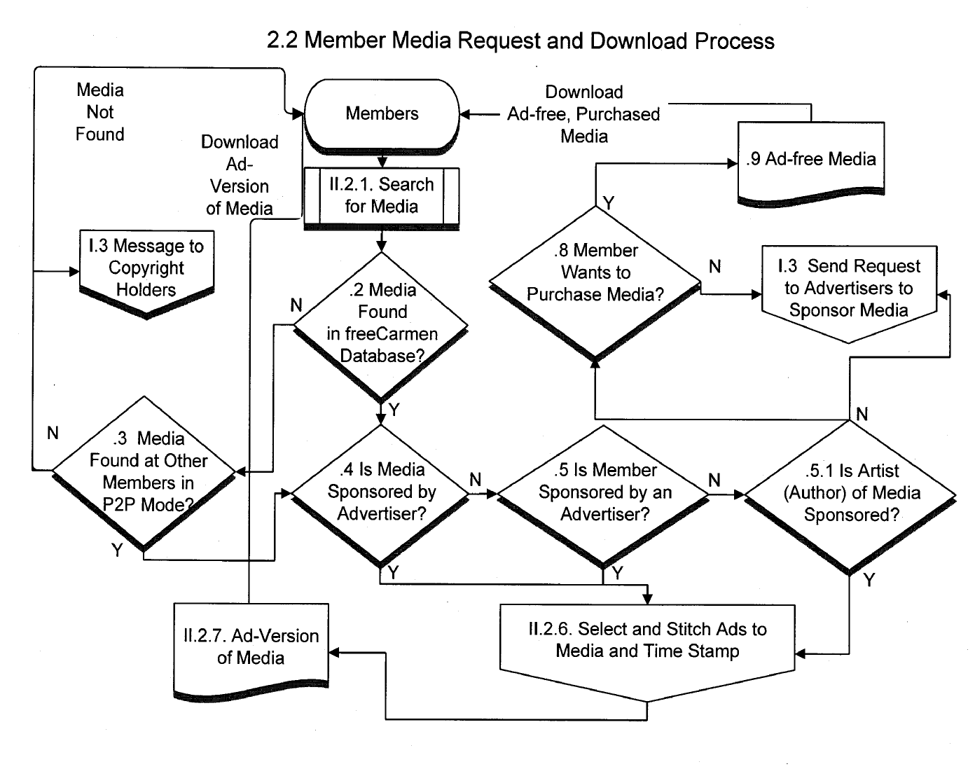

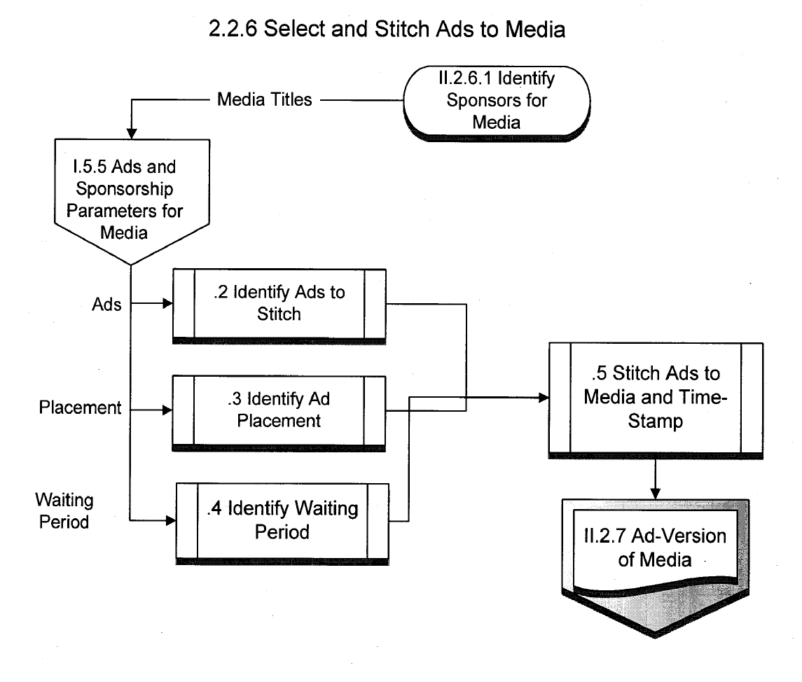

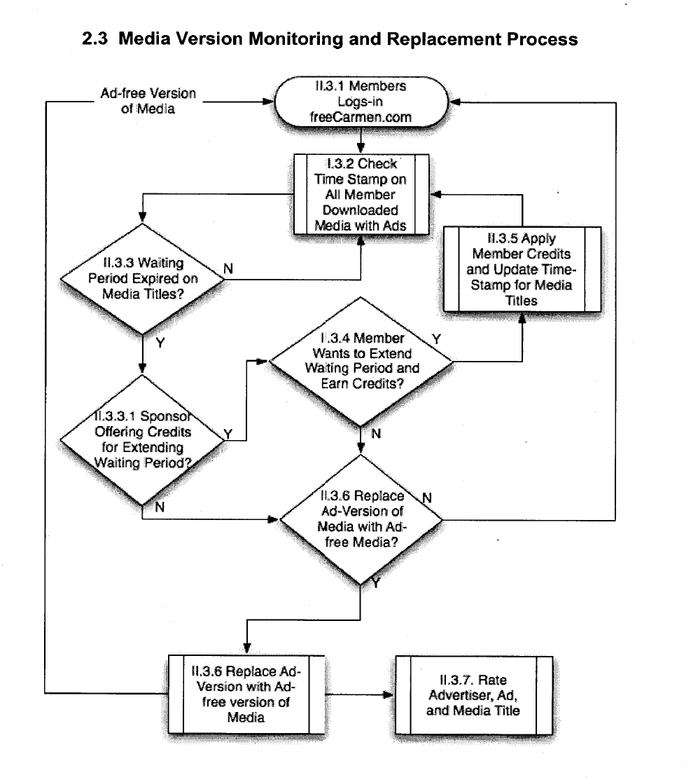

After completing the above processes, advertisers are ready to exercise the methods some of which are shown in 2.2.6 of FIG. 2.2, which allows for automatic selection of advertisements and stitching of these advertisements to media.

If the advertiser does not win the bid for the target in question; the system web site will recommend other targets that are in the bid range (based on all bid conditions) of the advertiser. If the advertiser wants to bid on the suggestions, the 1.5.2 process will be repeated.

If the advertiser does not want to bid on the suggested targets, the system web site will automatically notify the advertiser when its preferred targets become available in the original bid range. The advertiser will then exercise the 1.5 process to bid on the desired target.

FIG. 2 depicts a block diagram for the overview of member and media processing, according to an embodiment of the invention. The system delivers content to members who request content. This process registers members as authorized users of the system, allows the members to request media downloads, packages requested media with appropriate advertisements, and downloads the digital packages to member's devices.

FIG. 2.1 is a flow diagram depicting the member registration process, according to an embodiment of the invention. Before requesting content, members must register with the system. In this step, digital media consumers register at the system web site to become authorized members who can search and download sponsored media. The registration process records information about member's profile, file sharing preferences, and interests in digital media content, such as types of music or movies, genre of audio books, etc.

A digital media consumer visits the system web site to register as a member. The system collects all relevant information about the prospective member, and establishes an account that contains all this information. At this point, the prospect becomes a member with a user name and password that the member can use to access and use the services of the system web site.

If the member wants to share media titles, the member stores on the member's local device in P2P sponsored downloading mode, then, in this step, the member identifies all the files to share, and makes them available to the system's search capabilities.

The member is asked to provide information about her profile and preferences including artists and authors whose works the member is interested in. This information is used by the system to offer the member works of these authors and artists as they are made available for sponsored downloading. The member is also asked to provide demographic information such as age, sex, race, etc. This information is used by the system to offer advertisers to identify and sponsor media that are most popular with members in this demographic group. The member also provides information about media titles, genres, etc.—this information is used by advertisers to determine what to sponsor in order to reach specific members with their advertisements. This information is also used by the system to offer sponsored media titles to members as they become available. All the information provided by the registered member is consolidated, organized and stored in the system member database for processing.

FIG. 2.2 is a flow diagram illustrating the member media request and download process, according to an embodiment of the invention. Once members have registered, they may request and download content. As shown below, members use this process to search for sponsored media and download them to their device.

Members use keywords for artists, genres, media titles, or other search criteria to search for media that are available for download. If the media is found in the system's music/media database, then steps 2.2.4, 2.2.5, and 2.2.5.1 determine if the media is sponsored or not. If the media is sponsored, then in step 2.2.6 the sponsor's advertisement is stitched to the media and the advertisement is time-stamped (details of this process are described later). In step 2.2.7 the ad-version of the media is downloaded to the member's device

If in steps 2.2.4-2.2.5.1 it is determined that the media is not sponsored, then in step 2.2.8 the system gives the member the option of purchasing the media, and sends a message to advertisers to sponsor the media (using 1.3 process). The member can purchase the media with money or accumulated credits. As specified in step 2.3 below, members can earn credits for extending the waiting period on ads they receive with other sponsored media. If the member agrees to purchase the media, an ad-free version of the media is then downloaded on the member's device.

If in step 2.2.2 the requested media is not found in the system music/media database, then in step 2.2.3 the system checks to see if the requested media is available from other members, in sponsored P2P sharing mode. If the media is available in P2P mode, then steps 2.2.4-2.2.7 are exercised as above.

If the media in not available in P2P mode either, then a message is sent to the member that the requested media is not available for download. At the same time, through step 1.3, a message is broadcast to all copyright holders to post the requested media in the system and make it available for sponsorship and downloading.

Steps 2.2.4, 2.2.5 and 2.2.5.1 determine if the requested media is sponsored in title mode, artist/author mode, or market mode as follows. Step 2.2.4 checks to see if an advertiser is sponsoring the specific media title (through the bidding process).

Step 2.2.5 determines if the member who is requesting a sponsored download, based on her profile, is sponsored by an advertiser. Advertisers can choose to sponsor downloads of members whose profile provides a good match for a target audience the advertisers are trying to reach with their advertisements. If a member is sponsored by an advertiser, she can only download media titles that are not specifically sponsored in media title mode.

Step 2.2.5.1 checks to see if an advertiser is sponsoring the artist or author of the specific media title, which would imply that all or part of the media titles by the artist/author are sponsored, including the media title requested by a member for download.

FIG. 2.2.6 is a flow diagram depicting a process to select and stitch advertisements to media, according to an embodiment of the invention. When an advertisement is selected by the system, it is appended to the content. This sub-process describes the steps involved in identifying the sponsors of member requested media, reading advertisements and sponsorship parameters established in step 1.5.5, stitching the advertisements to sponsored media, and preparing an ad-version of the media ready for downloading.

In step 2.2.6.1, the sponsors of media are identified for further processing. Notice that more than one sponsor may be identified for each media title, based on the bidding process described in 1.5. For example, a song may have two sponsors; one advertiser may win the bid to place its advertisements at the beginning of the song, and a second advertiser may win the bid to place its advertisements at the end of the song. In this case, both sponsors will be selected for further processing.

Steps 2.2.6.2 through 2.2.6.4 use the information supplied by step 1.5.5 to select the appropriate advertisements, the placement of each advertisement in the media title, and the waiting period for each advertisement.

In step 2.2.6.5, all advertisements are stitched to the media, and time-stamps are registered for each advertisement in the member's account. The time-stamped advertisements can be recognized by special digital rights management (DRM) software, which resides on the member's device. The DRM software uses a capability called “time-bomb” to identify tagged and time-stamped advertisements in the media package, to expire them automatically, and expunge them from the media package, leaving the member with ad free version of the media file.

In step 2.2.6.7, the ad-version of the media is created for the member to download.

FIG. 2.3 is a flow diagram illustrating the media version monitoring and replacement process, according to an embodiment of the invention. Once content and advertisements are downloaded, the system monitors the package to determine when to give the member ad-free content. This process uses the time-stamp information to replace the ad-version of downloaded media with the ad-free version, as soon as the waiting period is over.

Members log-in to the system web site. After downloading sponsored media, members periodically visit their account at the system website to download other media or interact with other members, advertisers, and copyright holders.

The system automatically checks the current time, and compares the time with the time-stamps of the ad-version of the media.

If the waiting period has expired on the ad-version of the media, then the step 2.3.3.1 checks to see if the current sponsor is offering credits for extending the waiting period. If credits are offered, and in step 2.3.4 the member wants to earn credits by extending the waiting period for selected media titles, then in step 2.3.5 the time-stamps are refreshed and the ad-versions of the media are kept intact on the member's device.

If step 2.3.3.1 credits are not offered, or similarly, in step 2.3.4 the member does not want to extend the waiting period to earn credits, then in step 2.3.6 the ad-versions of the media are replaced by the ad-free versions automatically. This is accomplished by downloading an ad-free version of the files to the member's device, or by instructing software on member's device to expunge the advertisements from the ad-version of the files.

If in step 2.3.3 it is determined that the waiting period has not expired, then the ad-version of the files are kept intact on the member's device.

In step 2.3.7, the member is asked to rate, on some cardinal scale, the media title, the advertisement, and the advertiser. When rating a media title, a good rating by a member is used by the business method to strongly associate the media title, its genre, and other attributes implied, with the profile of the member and the target market the member represents. A bad rating will have the opposite effect. This information is used by the system's business method to help advertisers fine tune their advertisement targeting based on the types of media titles they sponsor.

When rating an advertisement, a good rating by a member tells the advertisers that their advertisements are appropriate for the target market represented by the member. A bad rating will prompt the advertiser to change its advertisements for the target market represented by the member.

When rating an advertiser, a good rating by a member will indicate that the advertisement is having the desired impact on the member. For example, if the advertiser's goal is to build brand awareness, then a good rating will indicate that its brand is being enhanced. A bad rating will indicate that the advertisements are not performing as they should.

Other information may be collected in this step to enhance advertiser's ability to maximize the impact of their advertisements by fine-tuning their advertisements, and the media titles they choose to sponsor.

Alternatively, members can set a preference in their profile that bypasses the process described in 2.3 and uses the “time-bomb” feature of DRM software to automatically expunge the advertisements from their media packages. Using this process, the DRM software residing on the member's device “reads” the time-stamp for the advertisement and the real clock of the device. As soon as the waiting period for the advertisements expire, the DRM software automatically deletes the advertisements from the media package without any member intervention.

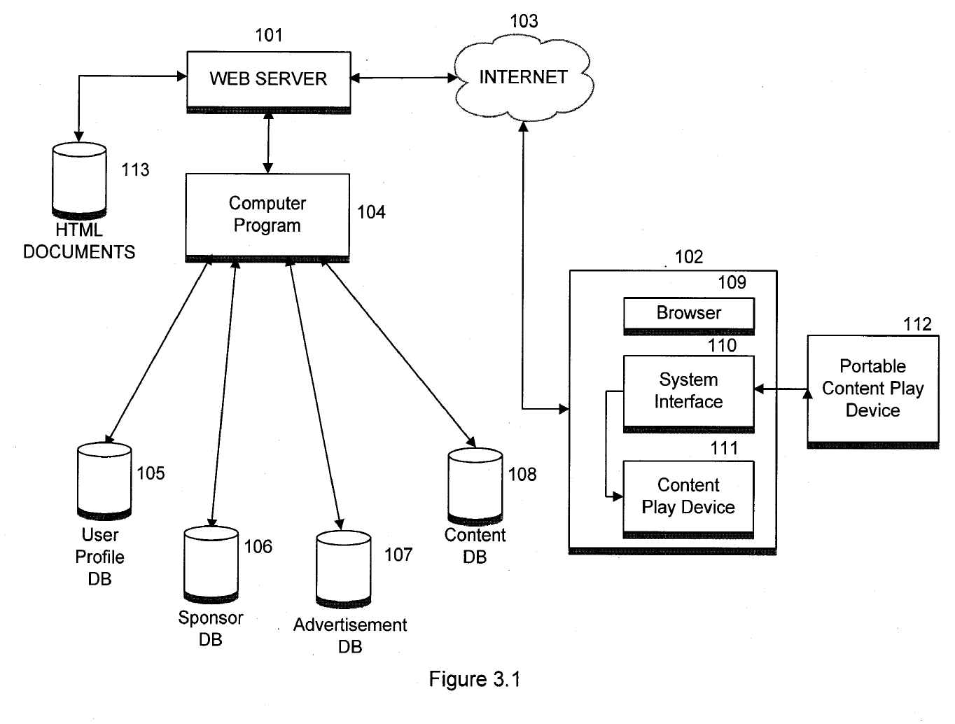

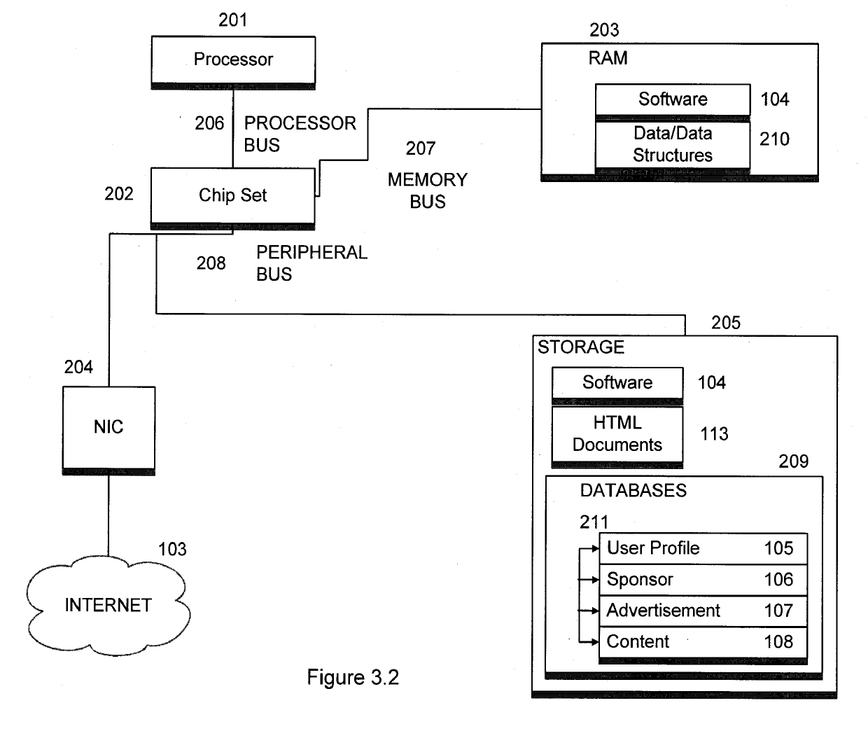

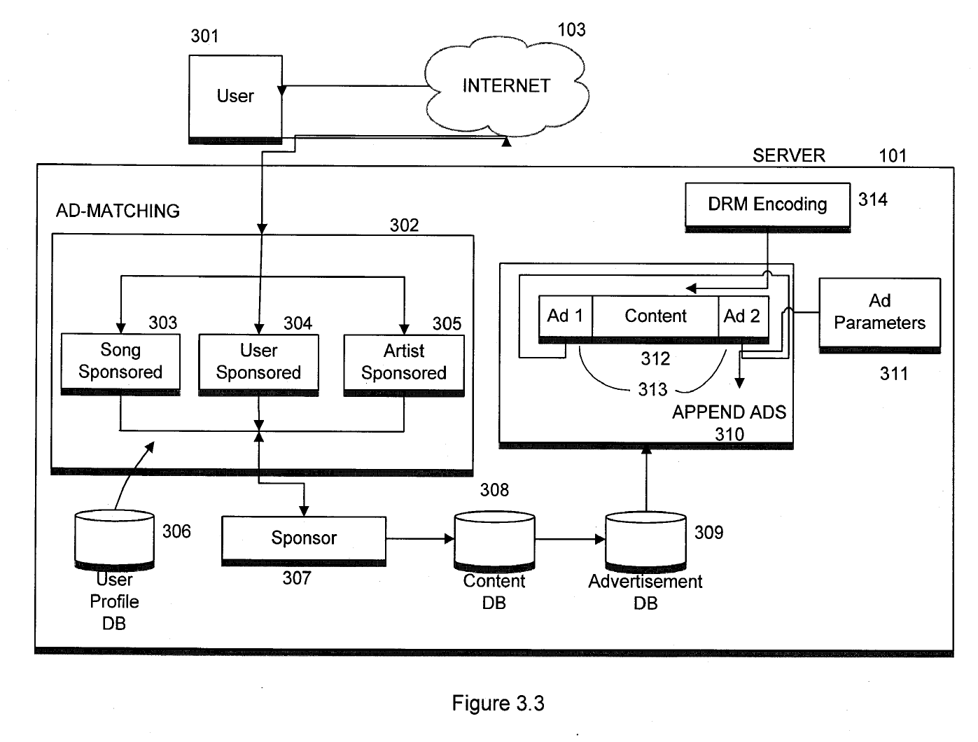

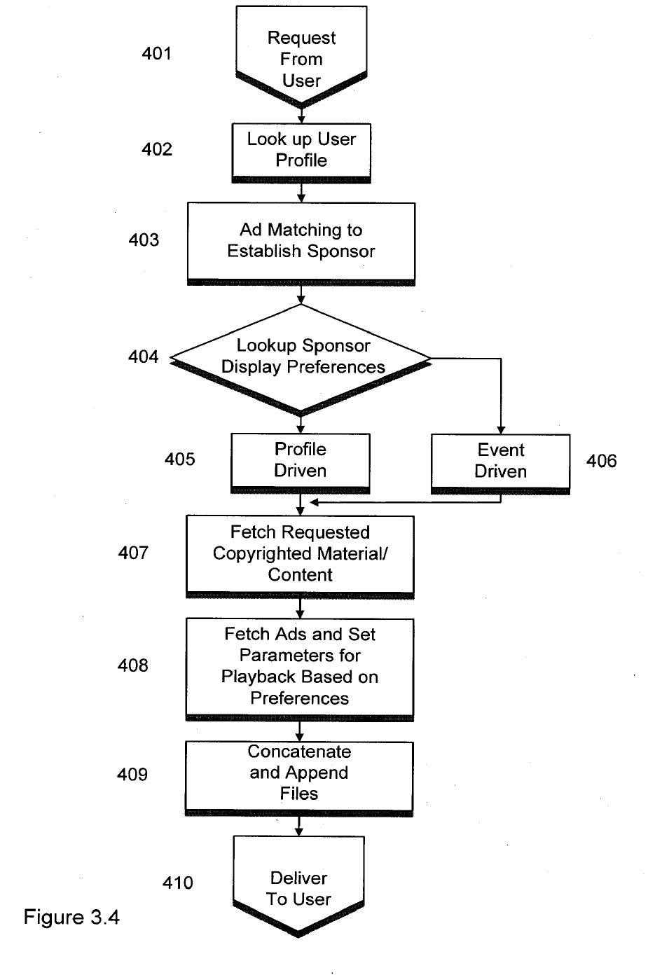

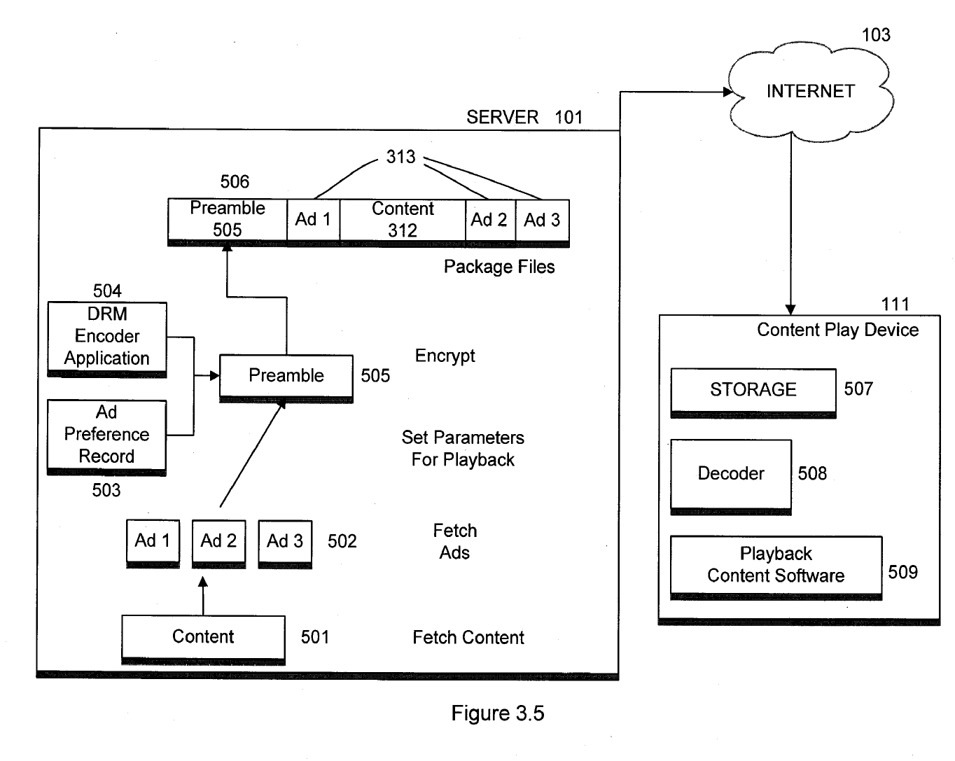

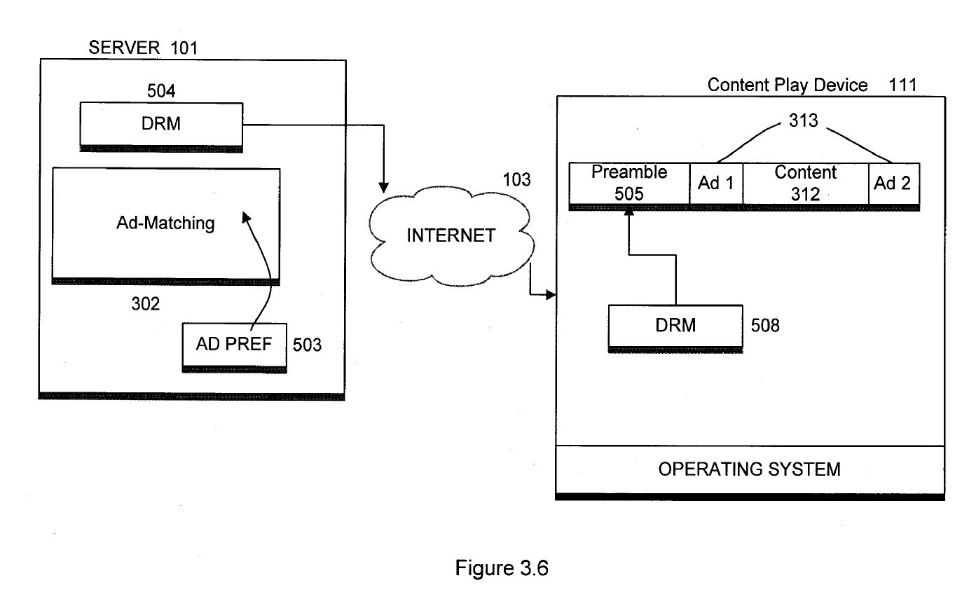

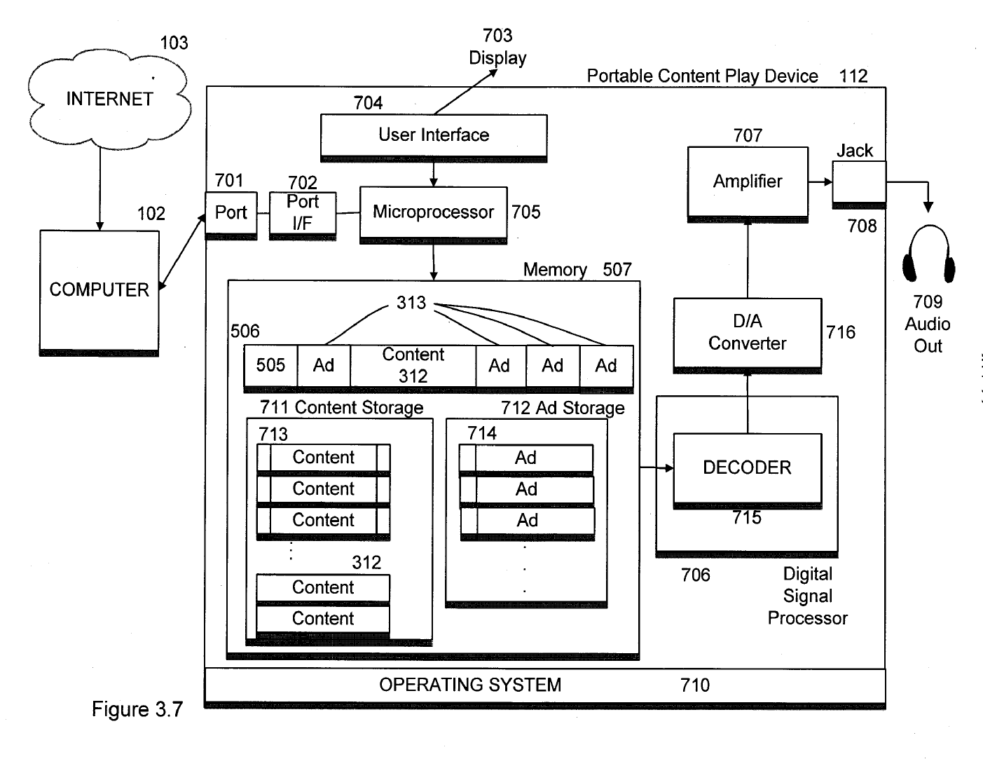

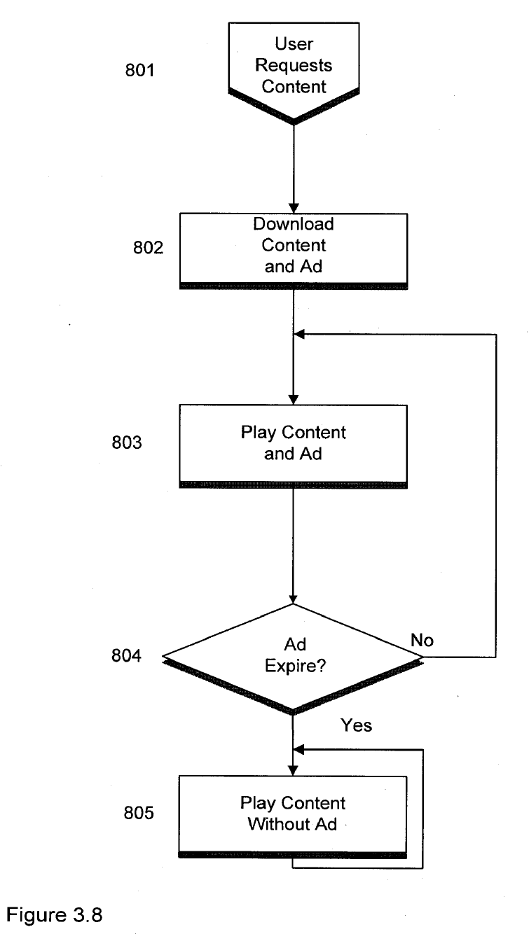

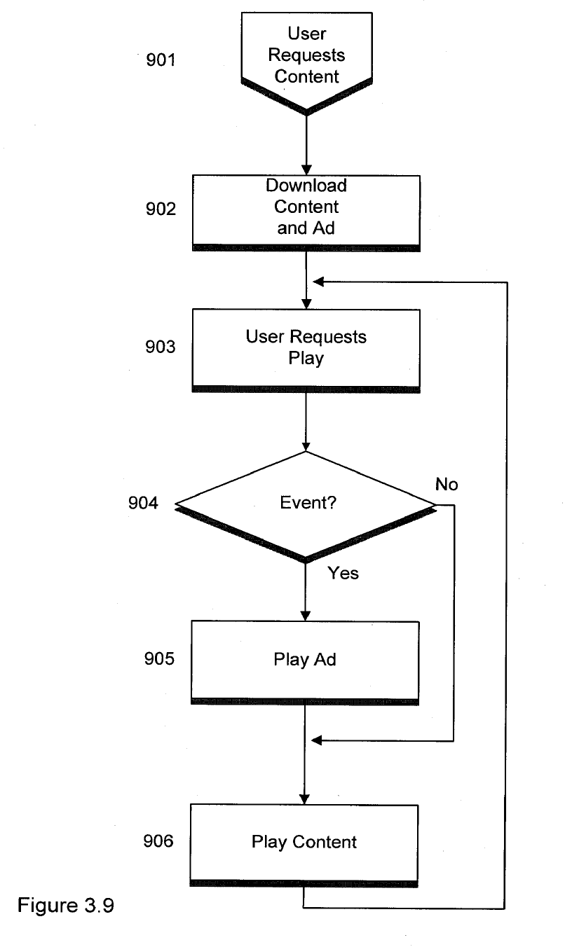

FIG. 3.1 is a block diagram illustrating a system, including a web server 101 and one or more client computers 102, which may download various digital content and advertisements, according to an embodiment of the invention.

The web server 101 communicates with the client computer over a network 103, such as the Internet or some other network such as a local area network (LAN) or intranet. FIG. 1 shows several elements (104, 105, 106, 107, 108) as separate items, although it will be understood that these items may all be part of the web server system 101 or may be distributed over other computers and storage systems and accessed by web server 101 or may be distributed over other computers and storage systems and accessed by web server 101 over a local area network (LAN) or other network. These elements include computer programs which include the software instructions executed by web server 101 and databases (105, 106, 107, 108).

The client computer 102 may include a web browser 109, or other client software for displaying web pages. The web browser 109 gives access to an interface 110 (such as a user interface) which allows client computer 102 to communicate with web server 101 over a network 103. The client computer 102 also includes a content play device 111, which may be a software application running on the client computer 102. The interface 110 interacts with the content play device 111 on the client computer as well as any portable content play devices 112 that may be plugged into the client computer 102.

The following is an example method used in connection with the system in FIG. 1 to allow sponsored downloads of digital content and the customized placement of advertisements that are downloaded along with the advertisements. The web server 101 provides a web site that acts as an interface for users using a client computer 102 to download digital content, for sponsors who wish to upload advertisements, or copyright holders who wish to set prices and upload copyrighted digital content. The web pages are served by web server 101 from a directory of HTML documents 113 on storage connected to the web server. The user submits a request to download digital content through the interface 110 on the web browser 109 via the Internet 103 to the web server 101. The web server then submits a request to a computer program 104 to append the appropriate advertisements from the advertisement database 107 to the requested digital content from the content database 108.

The computer program 104 uses information from the user profile database 105, the sponsor database 106, and the sponsor's advertisement preferences to determine which advertisements are appended to the requested digital content. According to various embodiments, an advertisement matching algorithm will choose advertisements based on what the sponsors choose to sponsor (groups of users, digital content, artists, or events), sponsor bid, advertisement parameters (where in the content the advertisements go, what causes them to expire), and advertisement type (audio, video, graphics, text, etc.).

Copyright holders, such as media companies, post digitized content to the web server 101 through an interface 110 on their client computer 102. This content is stored in the content database 108. The copyright holders specify a minimum bid per download of the content.

Sponsors submit a bid to sponsor different demographics of users, specific digital content, artists, or events. These specified criteria allow sponsors to narrowly target their advertisements. Sponsors who win the bid submit advertisements through the interface 110 on the web browser 109 via the Internet 103 to the web server 101. The web server stores the advertisement as well as any advertisement parameter information in the advertisement database 107.

FIG. 3.2 is a block diagram showing the architecture of a web server system according to an embodiment of the invention. As shown in the example embodiment of FIG. 2, the web server system may include a processor 201 for processing instructions. The processor is connected to a chipset 202 by a processor bus 206. The chipset 202 is connected to random access memory (RAM) 203 by a memory bus 207 and manages to access the RAM 203 by the processor 201. The chipset 202 is also connected to a peripheral bus 208. The web server system 200 also includes one or more network interface cards (NICs) 204 connected to the peripheral bus 208 for providing network interfaces to a network 103, such as Internet. External storage 205, such as a disk array or other non-volatile storage, is also connected to peripheral bus 208.

Software 104, databases 209, and HTML documents 113 are stored in external storage 205 for other computer readable medium and may be loaded into RAM 203 for use by the processor 201. Portions of data from databases 209 may be loaded into data structures 210 in memory 203 or other computer readable medium for manipulation by processor in accordance with software 104. The web server 200 includes an operating system for managing system resources, as well as application software running on top of the operating system. As shown at 211, the databases may contain cross references or links to one another to allow information to be queried and retrieved.

FIG. 3.3 is a block diagram showing the process to retrieve digital content within a web server 101 when a user requests digital content, according to an embodiment of the invention. FIG. 3.4 is a flow diagram showing the steps that take place within a web server when a user requests digital content, according to an embodiment of the invention. As shown in the example embodiment, the user 301 makes a request for media content (block 401) which is communicated over a network 103, such as the Internet or some other network, to the web server 101.

On the web server 101, the song request goes through an advertisement-matching algorithm 302, (block 403) which returns one or more sponsors if any exist. In one embodiment, the user 304, the artist 305, or the song 303 may be sponsored. The advertisement-matching algorithm may look at the user profile 306 (block 402) and song request and determine the chosen sponsors 307 based on who or what is sponsored, the bid amount, and the advertisement parameters that the sponsor has specified 404. The sponsor advertisement parameters may be profile driven (block 405) or event driven (block 406).

Once a sponsor is selected 307, on the web server 101, the requested content is chosen from the copyrighted files database 308 (block 407) as well as the selected advertisements from the advertisement database 309 (block 408). Then the advertisements are appended to the content 310 (block 409). The advertisements may be appended to any part of the file. For example, for an audio mp3, an advertisement may be appended to the beginning and the end of the song. Or in a video file, an advertisement may be appended at the beginning and end, and at some points in the middle. The advertisement parameters 311 for each of the selected advertisements 313 are appended to the file 312, and the entire package is encoded using some type of digital rights management (DRM) application 314.

DRM encrypts the digital work and distributes both the encrypted package and decryption key to the client computer's system (block 410). The party distributing the content may choose to restrict what the user can do with such distributed content. For example, the content owner may wish to restrict the user from copying and redistributing such content to a second user, or may wish to allow distributed digital content to be played only a limited number of times, only for a specified total time, only on a specified type of machine, and so forth according to the appended advertisement parameters.

The encrypted package is then delivered from the web server 101 over the network 103 back to the user 301 on the client computer (block 410).

FIG. 3.5 is a block diagram illustrating how DRM encodes the file to be delivered to the user, according to an embodiment of the invention. FIG. 5 shows the system 500, including a web server 101 that communicates with a content play device 111 on a client computer (such as client computer 102) over a network 103, such as the Internet or some other network. In a separate embodiment, the web server 101 communicates with a portable content play device (such as portable content play device 112) which is connected to a client computer.

The web server 101 encodes the content using some form of DRM. The web server 101 fetches the content 501, and fetches the advertisements 502 selected according to the results of the advertisement matching algorithm. Each of the advertisements has an advertisement preference record 503, created by the advertiser, which sets the parameters for playback. The advertisement parameters are encoded using a DRM application 504, and are appended to the content and advertisement files in a type of preamble 505 that the DRM application 504 on the client side will know how to read. The file being sent from the web server 101 is a packaged file 506 containing the preamble 505 with the advertisement parameters, the content 312, and the advertisements 313, all of which are encrypted.

The content play device 111 includes some form of storage 507, such as a disc array, or other non-volatile storage. The content play device also includes a DRM decoder 508, which may decrypt the encoded packaged file. A content playback software application 509 allows the content play device to actually play back the content.

FIG. 3.6 is a block diagram illustrating how DRM works to encode and decode the packaged files, according to an embodiment of the invention. FIG. 6 shows the system, including a web server 101 that communicates with the content play device 111 over a network 103, such as the Internet. The web server 101 encodes the packaged file while the content play device decodes the packaged file.

As discussed, the advertisement parameters 503 are inputted into the advertisement-matching algorithm 302 to determine the sponsored advertisements for the requested content. The advertisement parameters 503 are then encoded using the DRM application 504, which tacks it to the file as a type of preamble and encrypts the entire file. The packaged file is sent over the network 103 to the content play device 111.

The content play device 111 also has a DRM application 508 that is able to read the encryption. The DRM 504 from the server side also sent the decryption key to the client computer. The DRM 508 on the content play device reads the encoded preamble 505, which determines the advertisement parameters.

FIG. 3.7 is a block diagram showing the architecture of a portable content play device 112, according to an embodiment of the invention. The portable content play device 112 is connected to a client computer 102 which is connected to a network 103, such as the Internet or some other network, through a port 701, which is internally connected to a port interface 702. The portable content play device 112 also communicates with user via a user interface 704, which is also connected to a display 703. For example, the display may include a computer monitor, or an LCD panel, or any other suitable user communication means. The user interface 704 is coupled with a microprocessor 705, which is connected to the memory storage 507. The microprocessor 705 of the portable content play device 112 interprets the instructions and processes the data contained in the various computer programs. The microprocessor 705 also monitors user input, displays information about the current content on the display 703 and sends directions to the digital signal processor chip that tells it exactly how to process the audio. The port interface 702 is also connected to the microprocessor 705.

The packaged file 506 from the web server 101 is placed in memory storage 507 of the content play device 112 When the DRM application decrypts the packaged file 506, the content 312 and advertisements 313 are placed in a content storage database 711 and an advertisement storage database 712 respectively. When the advertisement parameters are profile-driven, the advertisement parameters, the content, and the advertisement remain as one package 713 and are stored in the content storage database 711. When an advertisement expires, the appended advertisement 313 and advertisement parameters are removed and only the content 312 remains in the content storage database 711. When the advertisement parameters are event-driven, only the content 312 is stored within the content storage database 711, and the advertisement parameters with the advertisements 714 are stored within the advertisement storage database 712. When the advertisements 714 in the advertisement storage database 712 expire, they are removed from the database.

The memory storage 507 is connected to the digital signal processor 706. The digital signal processor 706 includes a decoder 715. The decoder 715 runs a decompression algorithm that undoes any compression on the content file. The digital signal process is coupled to a digital-to-analog (D/A) converter 716, which turns the digital bytes back into sound waves. The digital signal processor 706 is also connected to an amplifier 707 which increases the strength of the signal and sends it to the jack 708, through which the content goes out. The jack may be connected to some form of audio device such as speakers or headphones 709.

Also on the portable content play device 112, an operating system 710 is running in the background and managing the hardware and software resources. The operating system 710 also manages processes which are controlled by the microprocessor 705.

In an alternative embodiment, the portable content play device 112 of FIG. 7 may represent a content play device 111 which is an application running on the client computer 102.

FIG. 3.8 is a flow diagram of when the advertisement parameters are profile-driven, according to an embodiment of the invention. The user first requests content from the content provider 801. The user then downloads the content and advertisements 802. The download is time-stamped. The user then plays the content and the appended advertisements 803. The advertisement parameters of each of the advertisements may be based on a length of time the advertiser wishes the song to play. For example, the advertisement may expire within five days from when the user starts listening to the song. Alternatively, the advertisement parameters may also include a specified number of times for the advertisement to be played back. For example, the advertisement may expire when it is played five times. It would be possible to program the package so that the advertisement would not play more than once a day.

The program determines whether the advertisements have expired 804. As long as the advertisement has not expired, whenever the user plays the content on the content play device, the play device will play the content with the appended advertisements 803. Once the advertisements expire, the advertisements are removed and the user can listen to the content free of advertisements 805.

FIG. 3.9 is a flow diagram of when the advertisement parameters are event-driven, according to an embodiment of the invention. The user first requests content from the content provider 901 and downloads the content and advertisements 902. When the advertisement parameters are event-driven, the advertiser may specify specific events for which the advertisement may play. For example, an advertiser may specify to play a flower delivery advertisement if the content play device is playing downloaded content the week before Mother's Day. Another example is an advertiser may wish for a coffee advertisement to play if the content play device is playing early in the morning or late at night.

When the user requests to play the content on the content play device 903, the content play device determines whether a pre-determined event has occurred 904. If the event has occurred, then the content play device will play the advertisement 905 along with the content 906. If the event has not occurred, the content play device will play the content alone 906.

The event-driven and profile-driven advertising parameters may be combined in another embodiment of the present invention. For example, the advertiser may specify that the advertisement only play for a particular event, but then place a time limit. One example is if the event does not occur while the content device is playing within six months, the advertisement will automatically expire. In another example, the advertiser may specify the advertisement only play for a particular event, and only play three times total, so that the advertisement is not hanging around forever. Any of these advertising parameters may be combined.

While this invention has been described and illustrated with reference to particular embodiments, it will be readily apparent to those skilled in the art that the scope of the present invention is not limited to the disclosed embodiments but, on the contrary, is intended to cover numerous other modifications and equivalent arrangements which are included within the spirit and scope of the following claims.

Aspects of the systems and methods described herein may be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits (ASICs). Some other possibilities for implementing aspects of the systems and methods include: microcontrollers with memory, embedded microprocessors, firmware, software, etc. Furthermore, aspects of the systems and methods may be embodied in microprocessors having software-based circuit emulation, discrete logic (sequential and combinatorial), custom devices, fuzzy (neural network) logic, quantum devices, and hybrids of any of the above device types. Of course the underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, etc.

It should be noted that the various functions or processes disclosed herein may be described as data and/or instructions embodied in various computer-readable media, in terms of their behavioral, register transfer, logic component, transistor, layout geometries, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, email, etc.) over the Internet and/or other computer networks via one or more data transfer protocols (e.g., HTTP, FTP, SMTP, etc.). When received within a computer system via one or more computer-readable media, such data and/or instruction-based expressions of components and/or processes under the systems and methods may be processed by a processing entity (e.g., one or more processors) within the computer system in conjunction with execution of one or more other computer programs.

Unless the context clearly requires otherwise, throughout the description and the claims, the words ‘comprise,’ ‘comprising,’ and the like are to be construed in an inclusive sense as opposed to an exclusive or exhaustive sense; that is to say, in a sense of ‘including, but not limited to.’ Words using the singular or plural number also include the plural or singular number respectively. Additionally, the words ‘herein,’ ‘hereunder,’ ‘above,’ ‘below,’ and words of similar import refer to this application as a whole and not to any particular portions of this application. When the word ‘or’ is used in reference to a list of two or more items, that word covers all of the following interpretations of the word: any of the items in the list, all of the items in the list and any combination of the items in the list.

The above description of illustrated embodiments of the systems and methods is not intended to be exhaustive or to limit the systems and methods to the precise form disclosed. While specific embodiments of, and examples for, the systems and methods are described herein for illustrative purposes, various equivalent modifications are possible within the scope of the systems and methods, as those skilled in the relevant art will recognize. The teachings of the systems and methods provided herein can be applied to other processing systems and methods, not only for the systems and methods described above.

The elements and acts of the various embodiments described above can be combined to provide further embodiments. These and other changes can be made to the systems and methods in light of the above detailed description.

In general, in the following claims, the terms used should not be construed to limit the systems and methods to the specific embodiments disclosed in the specification and the claims, but should be construed to include all processing systems that operate under the claims. Accordingly, the systems and methods are not limited by the disclosure, but instead the scope of the systems and methods is to be determined entirely by the claims.

While certain aspects of the systems and methods are presented below in certain claim forms, the inventors contemplate the various aspects of the systems and methods in any number of claim forms. Accordingly, the inventors reserve the right to add additional claims after filing the application to pursue such additional claim forms for other aspects of the systems and methods.

What is claimed is:

1. A method for distributing content, the method comprising:
requesting, through a computer network, a download of particular content;
receiving the particular content, wherein the particular content is combined with an advertisement;
storing the particular content and the advertisement in a user's content play device;
receiving a user request to play the particular content on the user's content play device;
determining whether the advertisement has expired;
if it is not determined that the advertisement has expired, in response to user request to play the particular content, playing the particular content on the content play device and the advertisement; and
if it is determined that the advertisement has expired, in response to user request to play the particular content, playing the particular content on the content play device without playing the advertisement.

2. The method of claim 1 including:
receiving, with the advertisement, information determining an expiration of play of the advertisement;
storing the information determining an expiration of play of the advertisement in the user's content play device; and
determining whether the advertisement has expired based on the information.

3. The method of claim 1 including:
storing a user profile; and
when a request is received, through the computer network, for download of particular content, accessing the user profile and selecting the advertisement(s) based on the user profile (using an algorithm for such selection).

4. The method of claim 1 including:
associating a first set of advertisements with the content and second set of advertisements with other content; and
selecting the advertisement from the first set of advertisements based on having received the request to download the particular content.

5. The method of claim 1 including:
associating at least one sponsor with the content, the sponsor having a set of one or more advertisements; and
selecting the advertisement from the sponsor's set of advertisements based on having received the request to download the particular content.

6. The method of claim 1 including determining whether the advertisement has expired using digital rights management.

7. A method for distributing content comprising:
requesting, through a computer network, a download of particular content;
receiving the particular content, wherein the particular content is combined with an advertisement;
storing the particular content and the advertisement in a user's content play device;
receiving a user request to play the particular content on the user's content play device;
determining whether it is within a particular time of occurrence of an event;
if it is determined that it is within a particular time of occurrence of an event, in response to a user request to play the particular content, playing the advertisement and the particular requested content on the content play device; and
if it is determined that it is not within a particular time of occurrence of an event, in response to a user request to play the particular content, not playing the advertisement on the content play device.

8. The method of claim 7 wherein the event comprises a birthday.

9. The method of claim 7 wherein the particular time comprises a particular amount of time in advance of the event.

10. The method of claim 7 wherein the particular time comprises any time within the range from two weeks in advance of the event until the event.

11. The method of claim 7 including:
storing a user profile; and
when a request is received through the computer network for download of particular content, accessing the user profile and selecting the advertisement based on the user profile.

12. A system for providing content, the system comprising:
database including content;
database including advertisements;
logic that receives a request for a particular item of content;
logic that based on the request, determines a sponsor for the content;
logic that obtains an advertisement of the sponsor from the database;
logic that obtains the requested content from the database;
logic that combines the content and advertisement; and
logic that sends the combined content and advertisement over the network for receipt by the user.

13. The system of claim 12 including logic that determines a sponsor based on the particular content.

14. The system of claim 12 including logic that determines a sponsor based on an artist of the content.

15. The system of claim 12 including logic that determines a sponsor based on information regarding the user.

16. The system of claim 12 including:
a database with user profiles; and
logic that determines the advertisement at least in part based on the user profile from the user profile database.

17. A system for providing content, the system comprising:
logic that obtains a particular item of content;
logic that obtains one or more advertisements;
logic that combines the content and the advertisement;
logic that provides parameters determining the play of the advertisement;
logic that combines the content and the advertisement and the parameters; and
logic that sends the combined content and advertisement and parameters over the network for receipt by a content play device.

18. The system of claim 17 wherein the parameters determine expiration of the advertisement.

19. The system of claim 17 where the parameters determine play of the advertisement in relation to an event.

20. The system of claim 17 wherein parameters are provided in a format that causes digital rights management software on a content play device to play the advertisement as determined.

21. The system of claim 17, wherein the content play device comprises:
logic that stores combined content and advertisement and parameters in content play device;
logic that reads parameters determining the play of the advertisement; and
logic that plays content and advertisements.

22. The system of claim 21 wherein logic that provides parameters determining play of the advertisement comprises digital rights management software.

23. The system of claim 21 wherein logic that reads parameters determining play of the advertisement comprises digital rights management software.

24. A device for playing content, the system comprising:
a digital input port;
a user interface for display of information related to content playback;
a decoder for decoding the content;
a digital to analog converter coupled to the decoder;
an amplifier coupled to the digital to analog converter;
an external audio output coupled to the amplifier;
storage with space for digital content and at least one advertisement and advertisement parameters that determine playback of the advertisement; and
logic that determines playback of the advertisement based on the parameters.

25. The device of claim 24 wherein logic that determines playback comprises digital rights management.

26. The device of claim 24 wherein the logic comprises software.

27. The device of claim 24 wherein the logic comprises circuitry.

28. A method for distributing content, the method comprising:
registering copyright holders with a system;
allowing copyright holders to upload content to the system;
allowing copyright holders to set a minimum bid on the uploaded content;
registering members with the system;
allowing a member to request content from the system;
registering sponsors with the system;
allowing sponsors to bid on sponsoring the requested content;
allowing sponsors to upload sponsor content to the system;
selecting sponsor content to go with the requested content;
appending the selected sponsor content to the requested content; and
delivering the requested content with the appended sponsor content to the requesting member.

29. The method of claim 28, wherein:
the sponsors comprise advertisers; and
the sponsor content comprises an advertisement.

30. A method for distributing content, the method comprising:
delivering content requested by a member to the member with an appended advertisement;
monitoring the delivered content; and
replacing delivered content with an ad-free version of the delivered content.

31. The method of claim 30, further comprising asking the member who requested the content to rate the advertiser, advertisement, and the delivered content.

32. The method of claim 30, wherein monitoring delivered content comprises:
checking a timestamp on a member's download;
determining whether an advertisement has expired;
if it is determined that the advertisement has not expired, checking the time stamp on the member's download;
if it is determined that the advertisement has expired, determining whether the advertiser is offering credits for extending a waiting period before expiration;
if it is determined that the advertiser is offering credits for extending the waiting period, determining if the member wants to extend the waiting period; and
if it is determined that the member wants to extend the waiting period, applying the member's credits, updating the time stamp for the content, and checking the timestamp on the member download.

33. A method for distributing content, the method comprising:
allowing copyright holders to set a minimum bid on content uploaded to the system;
receiving a request to download content;
allowing sponsors to bid on requested content;
determining if the copyright holder accepts bid terms from sponsor for the request content;
if it is determined that the copyright holder does not accept the bid, allowing copyright holder to send counter-bids to the advertiser;
if it is determined that the copyright holder does accept the bid, specifying business terms to download content, allowing members with sponsored transactions to download content free of charge, and determining if the winning sponsor offers credits to extend the waiting period; and
if it is determined that the winning sponsor does offer credits to extend the waiting period, allowing members to purchase unsponsored content with credits.

34. The method of claim 33 wherein allowing sponsors to bid on requested content comprises:
considering cost per download;
considering the length or type of the waiting period; and
considering the advertisement placement in relation to the content.
